(19) United States
(12) Patent Application Publication
(10) Pub. No.: US 2003/0115375 A1
(43) Pub. Date: Jun. 19, 2003

(54) Methods and apparatus for delayed event dispatching

(76) Inventor: Terry Robison, Citrus Heights, CA (US)

Correspondence Address: HEWLETT-PACKARD COMPANY, Intellectual Property Administration, P.O Box 272400, Fort Collins, CO, 80527-2400, US

(21) Appl. No.: 10/022,786

(22) Filed: Dec. 17, 2001

(51) Int. Cl. G06F 9/46; G09G 5/00

(52) U.S. Cl. 709/318; 345/763

(57) ABSTRACT

In one configuration, the present invention provides a method for operating a computer that includes: (a) preselecting at least a first time limit and a second time limit; (b) receiving an event signal from an event source; (c) adding a change event corresponding to the received event signal to a list of change events in a memory of the computer; (d) iteratively repeating steps (b) and (c) while neither the first predetermined time limit between consecutive the event signals is exceeded nor the second predetermined time limit since the receipt of a received event signal corresponding to a first change event in the list of change events is exceeded; and (e) dispatching the list of change events for a thread upon expiration of any of the first predetermined time limit or the second predetermined time limit.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates to methods and apparatus for monitoring and responding to events in computer systems, and more particularly to methods and apparatus that efficiently handle occurrences of both isolated events and floods of events.

### BACKGROUND OF THE INVENTION

In some programming frameworks, event handlers are used to monitor events that are to be handled by a running program. For example, operating systems that support graphical user interfaces monitor physical devices such as the mouse and keyboard. The operating system detects activations of physical devices and responds by transmitting an “event.” Events are signals transmitted from an event source, in this case the operating system, to an event listener. A task of the event listener is to receive the signal and determine what to do in response to the signal. In an object-oriented paradigm, the event listener is a “listener object” that is an instance of a class that implements a listener interface. To provide the interface, the object invokes an appropriate method, which may do nothing or it may react in some way to the event.

In one known database system, a database server is configured to receive database transactions that alter records in a database. As a result, zero or more database change events are sent to one or more GUIs (graphical user interfaces) data listeners with refresh methods. The GUIs display a portion of the records in the database, or at least some of the fields therein. If no events are sent to a GUI data listener, the GUI is not affected because the refresh method is not called. If a single database change event is sent to a GUI data listener refresh method, the GUI refreshes once to incorporate the changed field or record into its display.

More or less often, depending upon the database and the frequency and type of database transactions, a single database transaction results in a cascade of changes to the database as a result of internal database relationships and/or dependencies. When this occurs, each change in the cascade of changes produces a database change event that to which the GUI data listener responds. As a result, the GUI refreshes multiple times as a result of what appears to be a single change or update to the database. GUI refreshes may become so frequent that they hinder the usability of the GUI interface.

### SUMMARY OF THE INVENTION

One configuration of the present invention therefore provides a method for operating a computer that includes: (a) preselecting at least a first time limit and a second time limit; (b) receiving an event signal from an event source; (c) adding a change event corresponding to the received event signal to a list of change events in a memory of the computer; (d) iteratively repeating steps (b) and (c) while neither the first predetermined time limit between consecutive the event signals is exceeded nor the second predetermined time limit since the receipt of a received event signal corresponding to a first change event in the list of change events is exceeded; and (e) dispatching the list of change events for a thread for actions dependent upon the change events upon expiration of any of the first predetermined time limit or the second predetermined time limit.

Another configuration of the present invention provides a computing apparatus having a central processing unit operatively coupled to a memory. The computing apparatus is configured to: (a) store a predetermined first time limit and a predetermined second time limit in the memory; (b) execute a plurality of concurrent program threads; (c) construct a list of change events corresponding to event signals received by one the program thread while neither the first predetermined time limit between consecutive the event signals is exceeded nor the second predetermined time limit since the receipt of an earliest received event signal corresponding to a first change event in the list of change events is exceeded; and (d) dispatch the list of change events for a thread for actions dependent upon the change events upon expiration of any of the first predetermined time limit or the second predetermined time limit.

Yet another configuration of the present invention provides a machine-readable medium or media having recorded thereon instructions configured to instruct a computing apparatus having a central processing unit operatively coupled to a memory to: (a) store a predetermined first time limit and a predetermined second time limit in the memory; (b) execute a plurality of concurrent program threads; (c) construct a list of change events corresponding to event signals received by one the program thread while neither the first predetermined time limit between consecutive the event signals is exceeded nor the second predetermined time limit since the receipt of an earliest received event signal corresponding to a first change event in the list of change events is exceeded; and (d) dispatch the list of change events for a thread for actions dependent upon the change events upon expiration of any of the first predetermined time limit or the second predetermined time limit.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a representation of a cascade of event signals being generated in response to a database transaction and processed as a collection of change events in one configuration of the present invention.

FIG. 2 is a representation of the processing of individual events in a cascade as performed in the prior art.

FIG. 3 is a relationship diagram showing an overview of the class hierarchy in one configuration of the present invention.

FIG. 4 is a relationship diagram showing methods and classes related to the eventDispatcher class in one configuration of the present invention.

FIG. 5 is a relationship diagram showing methods and classes related to the delayedEventDispatcher class in one configuration of the present invention.

FIG. 6 is a relationship diagram showing methods and classes related to the delayedModelEventDispatcher class in one configuration of the present invention.

FIG. 7 is a relationship diagram showing methods and classes related to the GUIRefreshListener class in one configuration of the present invention.

FIG. 8 is a flow chart showing one state of operation of a delayed event dispatcher in one configuration of the present invention.

FIG. 9 is a flow chart showing a second state of operation of a delayed event dispatcher in one configuration of the present invention.

FIG. 10 is a simplified block diagram of a computing apparatus configured to carry out the methods described herein as instructed by machine-readable instructions recorded on a medium or media.

### DETAILED DESCRIPTION OF THE PREFERRED EMBODIMENTS

The following description of the preferred embodiment(s) is merely exemplary in nature and is in no way intended to limit the invention, its application, or uses.

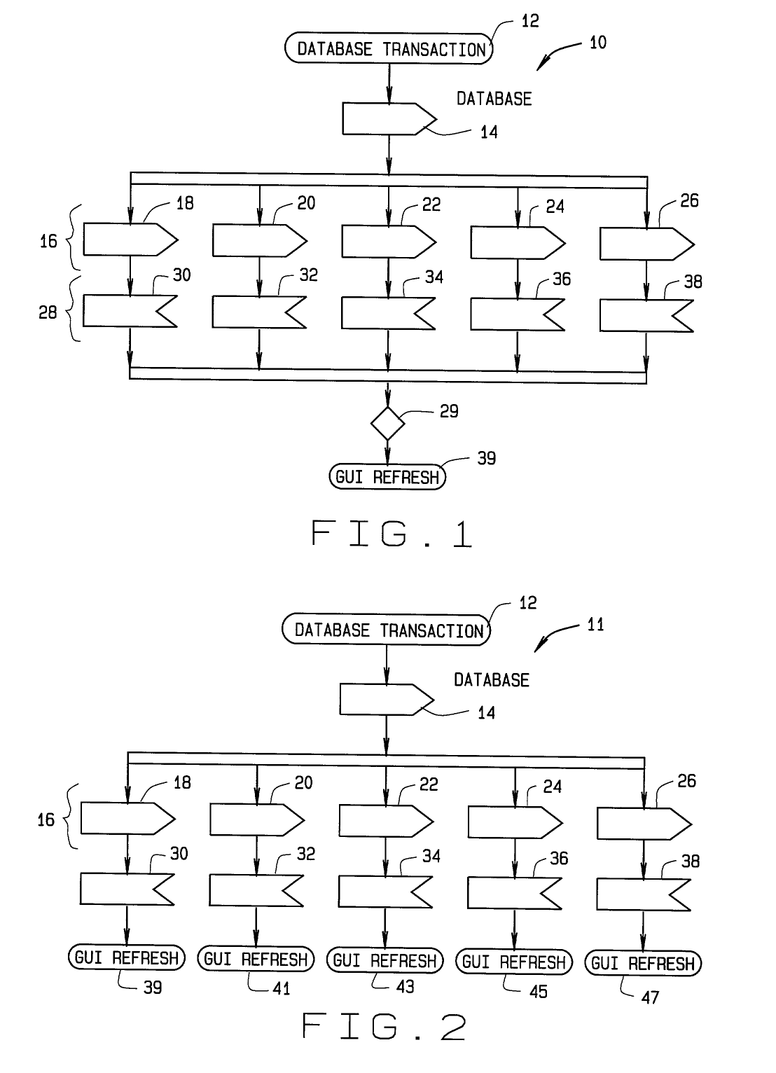

In one configuration 10 and referring to FIG. 1, delayed event dispatching is used to prevent rapidly occurring events from overwhelming a computing system having an associated memory. When a database transaction 12 occurs to a database server 14 or other event source that results in a cascade 16 of event signals (also referred to herein simply as “events”) 18, 20, 22, 24, 26, a list 28 (also referred to herein as a “dispatch list”) of change events 30, 32, 34, 36, 38 is built up in the memory. Event signals 18, 20, 22, 24, 26 are not limited to occurring within any particular frequency range or time interval. Thus, a single event signal such as event signal 18 can occur infrequently, or a large number of event signals 18, 20, 22, 24, 26 can occur in succession or in isolated bursts. (Five event signals and five corresponding change events are described and included in the figures to help illustrate a non-trivial sample configuration. However, the present invention imposes no inherent limit on the number of event signals and corresponding change events that can be handled, nor does it exclude the possibility of a limit being imposed as a result of implementation with limited memory or computational resources or as a result of a design choice.) To accommodate both infrequent and bursty arrivals of event signals, upon the receiving of a first event signal 18, one configuration of the present invention places a first change event 30 corresponding to first event 18 in a list 28.

The process of receiving an event signal and adding a corresponding change event to the dispatch list is iteratively repeated until either or both of two time-out conditions occur based upon predetermined first and second time limits that are stored in a memory of the computing apparatus. Namely, the receiving and adding steps are iterated while neither the first predetermined time limit between consecutive said event signals is exceeded nor the second predetermined time limit since the receipt of a received event signal corresponding to a first change event in the list of change events is exceeded. (Tests to determine whether a time limit is equaled, or whether a time limit is equaled or exceeded should be considered as equivalent to or the same as tests to determine whether the time limit is exceeded, because actions taken in consequence of equality necessarily occur after the time limit has been exceeded.) When any time limit is exceeded, the list of change events 28 is dispatched in its entirety to a GUI listener object 29, which processes all change events 30, 32, 34, 36, 38, and refreshes 39 the GUI with all of the processed changes all at once rather than repeatedly. Thus, instead of a GUI refresh 39, 41, 43, 45, 47 for each change event 30, 32, 34, 36, 38 of a cascade 16 of event signals 18, 20, 22, 24, 26 resulting from a database transaction 12 as in prior art configuration 11 represented in FIG. 2, configuration 10 of the present invention represented in FIG. 1 performs a GUI refresh 39 only once per transaction. More particularly, in one configuration, GUI listener object 29 buffers the effect of individual change events 30, 32, 34, 36, 38 until a cumulative effect of the plurality of change events is determined. The GUI is refreshed 39 only once in accordance with the determined cumulative effect of the changes.

In one configuration, the relevance of event signals 18, 20, 22, 24, 26 is determined in accordance with predetermined relevance criteria, and change events 30, 32, 34, 36, 38 are added to list 28 only for event signals meeting the predetermined relevance criteria. For example, if event signal 20 was indicative of a change in database 14 that was not relevant to a subset of information displayed on the GUI, no corresponding change event 32 would be placed in list 28 for event signal 20.

In one configuration, the process of iteratively receiving event signals and adding change events to the list of change events in memory while neither time limit has expired and then dispatching the list of change events is itself iteratively repeated in its entirety, with a new list of change events being constructed for each such iteration. Also in one configuration, the computing apparatus executing the configuration executes a plurality of concurrent program threads. One of the program threads may include event source 14.

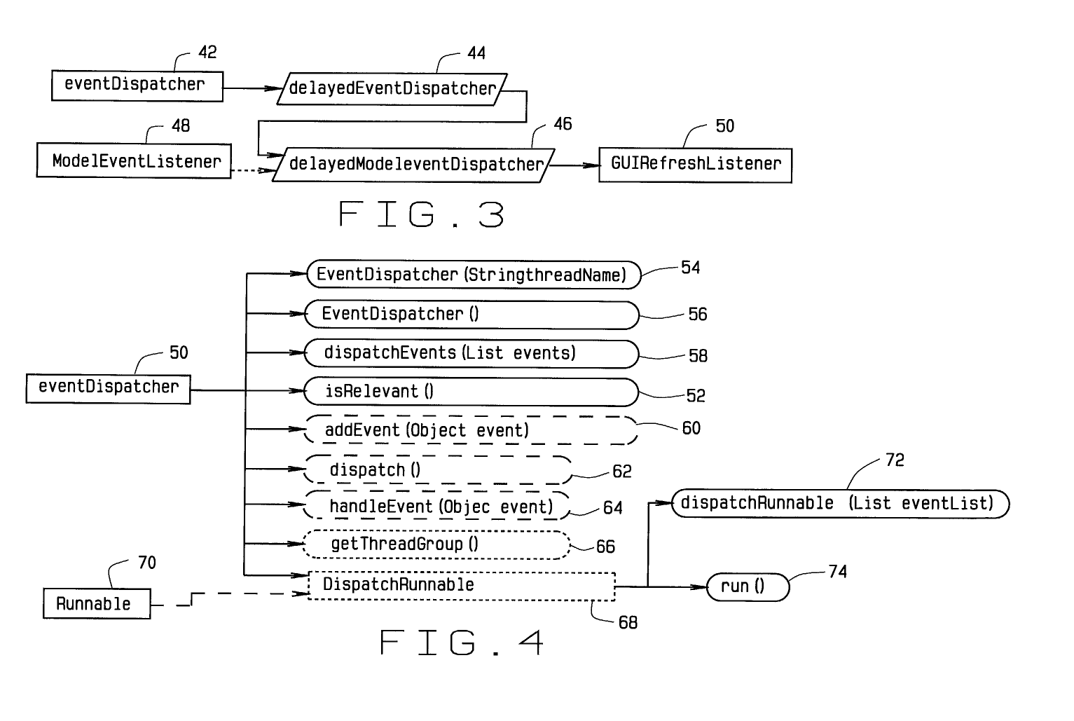

In one configuration and referring to the relationship diagrams in FIG. 3, 4, 5, 6, and 7, the GUI is a JAVA® application running on a terminal connected via a network to a database server. In FIGS. 3, 4, 5, 6, and 7, classes are represented by rectangles and abstract classes by parallelograms. Classes that extend other classes are connected by solid lines, while classes that implement other classes are connected by dotted lines. Public, protected, and private member functions (methods) and member classes are represented by solid ovals, dashed ovals and dotted ovals, respectively. The illustrated configuration is part of a specific database GUI display system. However, it should be understood that, in other configurations, the present invention is generally useful in systems in which floods of events occur and in which it is advantageous to operate on a dispatched list of events in such occurrences rather than on each individual event.

Referring more particularly to FIG. 3, which provides an overview of the relationship of some of the classes in this example. EventDispatcher 42 and DelayedEventDispatcher 44 are base classes that provide the functionality described above and in FIG. 2. DelayedModelEventDispatcher 46 is a type of listener 48 that is specific to the illustrated implementation, the details of which need not be of concern for present purposes. Class DelayedModelEventDispatcher is defined as an abstract class 46 in this configuration, so that an action to be performed must be added. In the GUI database system, GUIRefreshListener 50 is a class that extends delayedModelEventDispatcher 46.

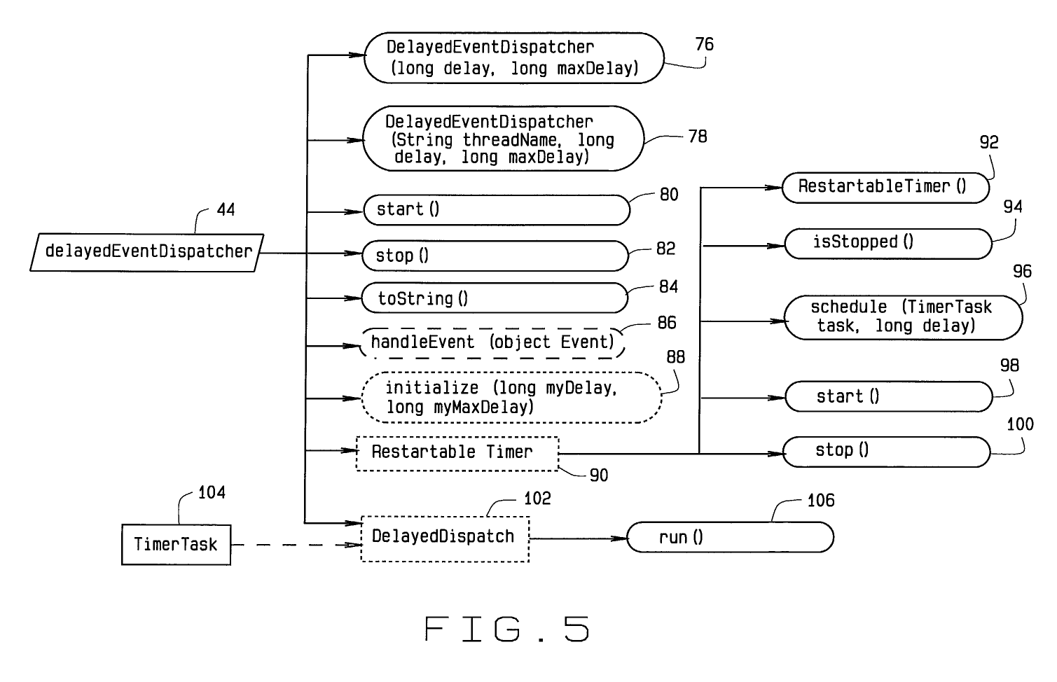

The eventDispatcher class 50 represented in FIG. 4 dispatches a list of events to an interested listener. This class is abstract and provides a mechanism for dispatching and filtering out all but the relevant events of interest, utilizing the isRelevant 52 method. By default, all methods are of interest, but classes that extend eventDispatcher can change this default. The eventDispatcher class does not specify how or when events are eventually dispatched, or the type of events to be dispatched. However, events are dispatched in the thread group for which the first event is received, or within the GUI thread. Class eventDispatcher 50 includes the following variables:

private static final String NAME
“EventDispatcherThread”;
private List events;
private ThreadGroup group;
private boolean dispatchInSwing;
private String threadName.

EventDispatcher method 54 creates a new event dispatcher that dispatches events in a thread using a specified thread name threadName. Events are dispatched in the thread group in which the first event is received. If threadName is null, a default thread name is used. EventDispatcher method 56 is similar to EventDispatcher method 54, except that it always uses the default thread name.

Method dispatchEvents 58 is called when a group of relevant events have been received, and it has been determined that they should be dispatched. The timing of when the dispatching should occur is left up to implementations of the EventDispatcher 54 or 56. The list passed to the method is a list of relevant events, in the order in which they were received. (Whether an event is added to the list when it is received is determined by the criteria defined by the isrelevant 52 method.)

Method addEvent 60 adds a new event to the list of events that are relevant to the listener. All members of the list are delivered to the listener when dispatch method 62 is executed. The first thread that calls this method (for a particular dispatch of events) is used for discovering the thread group to use for dispatching the list of events.

Method handleEvent 64 handles a received event by determining whether it is a relevant event using isRelevent method 52. If and only if the event is determined to be relevant, it is added to an ordered list of events to be delivered.

Method getThreadGroup 66 gets the thread group of the current thread if the currently defined thread group is null. Method getThreadGroup is used by addEvent method 60.

Private class DispatchRunnable 68 implements class Runnable 70. It runs in a separate thread to dispatch a collection of event changes and includes public method DispatchRunnable 72 to create a new dispatch runnable, and public method run 74, which dispatches the list of relevant model changes. Class DispatchRunnable includes the following variable:

private List eventList.

Referring now to FIG. 5, class delayedEventDispatcher 44 extends eventDispatcher class 50 shown in FIG. 4. Class delayedEventDispatcher 44 dispatches a list of relevant events after a specified delay has passed without any further events since the most recently received event. To avoid cases in which the list of relevant events is never dispatched because the specified delay is never exceeded, events are always delivered after a specified maximum length of time has elapsed since the most recently received event. Class DelayedEventDispatcher includes the following variables:

private long delay;

private long maxDelay;

private long lastEventTimeStamp;

private long maxDelayTimeStamp;

private boolean scheduled;

private RestartableTimer timer.

Method DelayedEventDispatcher 76 creates a new event dispatcher that dispatches events in the GUI thread. In one configuration, the delay parameter is the time that must pass in milliseconds, after the most recently received event, before all of the received events are dispatched as a list. If a negative value is specified, the specified delay is taken to be zero. Also, the maxDelay parameter is the maximum number of milliseconds to delay before the relevant received events are dispatched as a list. One configuration allows a negative maxDelay parameter to signal that no timeout is to be used, which may be desirable in cases in which no events are to be delivered when there is never a sufficient delay between events. However, a positive maxDelay value normally used.

Method DelayedEventDispatcher 78 is similar to DelayedEventDispatcher 76, except that DelayedEventDispatcher 78 dispatches a list of events in a thread using a specified thread name, threadname. If threadname is null, the default thread name is used.

Method start 80 starts the delayed event dispatcher, and should be called if the event listener is removed and then re-added. Method start invokes the timer's own start method.

Method stop 82 stops the periodic event dispatcher, and should be called if the event listener is removed from the ModelEventDispatcher. Method stop sets the variable scheduled to false and calls the timer with its own stop method.

Method toString 84 provides a simple string representation of delayedEventDispatcher 44.

Method handleEvent 86 handles a received event by determining whether it is a relevant event using the isRelevant method. If, and only if, a received event is a relevant event, it is added to the list of events to be delivered. More particularly, if the list is not scheduled to be dispatched, the variable maxDelayTimeStamp is updated. For example, in one configuration, the isRelevant method is checked, and if the event is deemed relevant it is added to the list of events. If the event deemed relevant is the first event to be received since the most recent dispatch, then the maximum time is determined (i.e., the current time plus the maximum time to wait) and a call back is initiated so that, after the minimum delay has occurred, the DelayedDispatch.run method is called to determine whether no events have occurred within the minimum time period or whether the maximum time has elapsed.

Method initialize 88 initializes the DelayedEventDispatcher by creating a dispatch timer. The delay values are also initialized. In one configuration, negative values of delay value and maximum delay values are treated specially, to control whether events are queued or timers are checked.

Private class RestartableTimer 90 of delayedEventDispatcher 44 is a restartable timer class that schedules tasks to be performed. It includes variables stopped and timer.

Method RestartableTimer 92 of private class RestartableTimer 90 initializes the re-startable dispatch timer by setting the variable stopped to false and initializing a new timer.

Method isStopped 94 of private class RestartableTimer 90 determines whether the timer has been stopped.

Method schedule 96 of private class RestartableTimer 90 schedules a task to be performed after the specified delay has occurred. Tasks can only be scheduled if the delayed event dispatch has not previously been stopped.

Method start 98 of private class RestartableTimer 90 starts the restartable timer.

Method stop 100 of private class RestartableTimer 90 stops the restartable timer.

Private class DelayedDispatch 102 extends class TimerTask 104 and is a dispatch class to signal events to be delivered after the specified delay. It includes variables currentTime, delayTimeStamp, newDelay, and newMaxDelay.

Method run 106 of private class DelayedDispatch 102 is invoked to determine whether all received events should be dispatched. Method run 106 determines whether the time elapsed since the most recently received event is greater than (or equal to) a first maximum time limit or whether the time that has elapsed since the most recent dispatch is greater than (or equal to) a second maximum time limit. If either condition is true, the list of events is dispatched. Otherwise, variables are updated in preparation for the next determination. In one configuration, method run 106 also handles special cases that are signaled by negative or zero values of the first and the second maximum time limits. In one configuration, a first check is made to determine whether an arrival time limit from the most recently received event has been exceeded, and if not, a second check is made to determine whether a maximum time limit is exceeded. If either time limit is exceeded, then an action is performed, and the list of events is cleared. The “action” is an action done in response to the events, which varies from configuration to configuration. Performing the action comprises handling the list of all received events since the most recent dispatch.

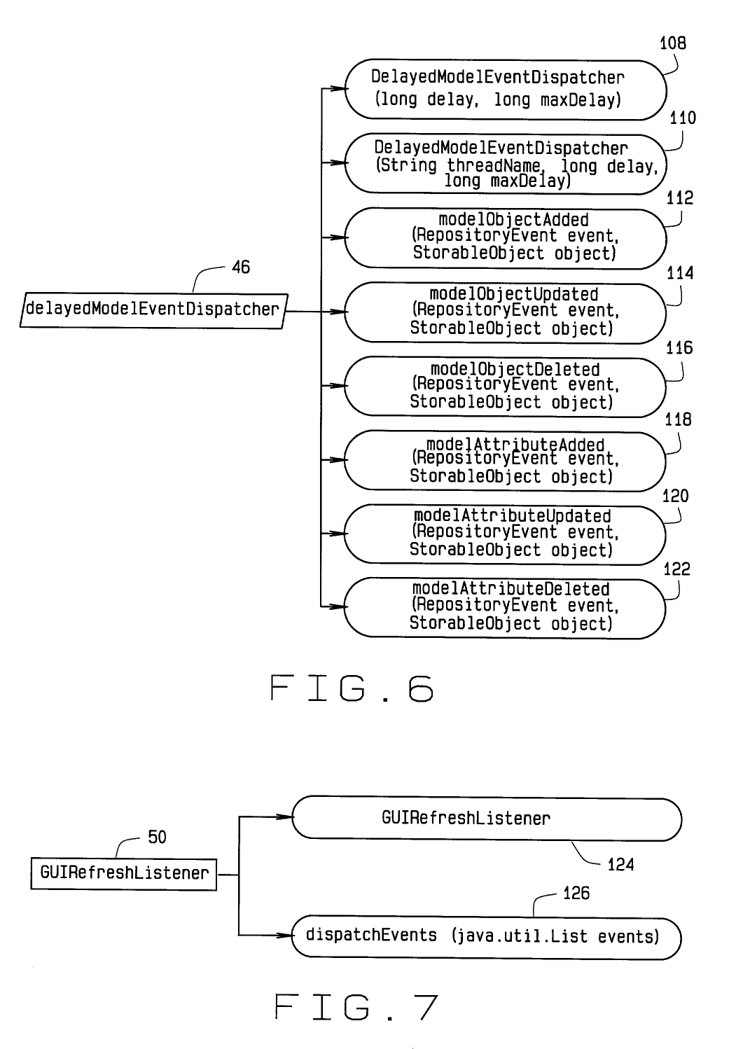

Referring now to FIG. 6, class delayedModelEventDispatcher 46 is a model listener that dispatches a list of changes to the model to an interested listener. The class is abstract and provides methods for listening to model events and filtering out all but relevant events of interest. Method isRelevant 52 (shown in FIG. 4) is used to determine whether an event is relevant, but relevancy may instead be determined by classes that extend ModelEventDispatchListener. The default isRelevant method always returns “true,” but classes that extend eventDispatcher may perform filtering by overwriting this method. In one configuration, an event is examined in method isRelevant and only if the event is deemed relevant will the timer be started (or reset if the received event is not the first event). There are no member variables in class delayedModelEventDispatcher 46. Class delayedModelEventDispatcher is an example of a specific type of listener (in this case, a listener for model event changes for a database abstraction layer used in a storage area manager product). However, those skilled in the art, upon studying the example presented here, would be able to recognize the modifications needed for other configurations of event dispatching systems that use an interface for defining its listeners and an event object to represent an event that has occurred. Methods in DelayedModelEventDispatcher 46, except for constructors 108 and 110, are methods used by the listening interface being implemented. In one configuration, the type of events are “model event change.” In addition, the methods are invoked upon receipt of an event, where the event corresponds to some change in the model, such as a table in the database being updated, a row being deleted, etc.

Classes extending eventDispatcher 50 can override the isRelevant method. The EventDispatcher handles received events by checking whether they are relevant and adding relevant events to a list. In one configuration, the EventDispatcher class does not have any methods to determine when received events should be dispatched, or how events should be received. Class delayedModelEventDispatcher 46, in one configuration, is a specific type of listener that conforms to an interface for receiving for receiving events, and that extends class delayedEventDispatcher 44. Class delayedModelEventDispatcher 46 is an example of how delayedEventDispatcher 44 can be used in listening for a particular type of event, by providing the ability to dispatch, a determination of when to dispatch, and a method by which events are received. Although the implementation of delayedModelEventDispatcher 46 is specific to a particular type of listening methodology, those skilled in the art will be able to analyze its implementation to determine those modifications that may be required for other types of listening methodologies.

Method DelayedModelEventDispatcher 108 creates a new model event dispatcher that dispatches model changes in a thread using the GUI thread. Two parameters are provided. The delay variable is the time that must pass in milliseconds from the most recently received event before the list of all of the received events are dispatched. In one embodiment, negative values of delay result in the delay being set to zero. The maxDelay variable is the maximum number of milliseconds to delay before the list of relevant events is dispatched. In one embodiment, if a negative value of maxDelay is specified, then no maximum delay is used. Negative values of maxDelay in this embodiment may be used if it is desired to allow a possibility of events not being delivered a sufficient delay between events never occurs.

Method DelayedModelEventDispatcher 110 is similar to DelayedModelEventDispatcher 108, except that model events are dispatched in a thread using the name threadName, or the default thread name. Events are dispatched in the connection context in which they are registered, or in the GUI thread, if specified. In one configuration implemented in JAVA, events are dspatched in a thread that is a member of the same TreadGroup in which the events would normally be delivered, or in the GUI thread.

Method modelobjectAdded 112 is invoked when an event has been received that indicates that a new object has been added. These events are “model event changes” that reference a change in the database. The “model” is an abstraction to a database schema in one configuration, and the events are changes to portions of the tables in that schema. The events are handed to a method “handleEvent,” in one configuration, as would typically be the case for all other classes that implement a listener. Method modelObjectAdded 112 is invoked with an event parameter, which is a repository event associated with the model change, and an object parameter, which is a storable object associated with the model change.

Method modelobjectupdated 114 is invoked when an event has been received that indicates that an object has been updated.

Method modelobjectDeleted 116 is invoked when an event has been received, which indicates that an object has been deleted. In one configuration, if a cached copy of the object existed, this copy is passed to each listener before it is removed from the cache.

Method modelAttributeAdded 118 is invoked when an event has been received that indicates that a new attribute has been added. This method is used in one configuration in which the database model has tables associated with other tables to which additional information can be associated with a row. These attributes can be added, deleted, and updated.

Method modelAttributeUpdated 120 is invoked when an event has been received, which indicates that an attribute has been updated.

Method modelAttributeDeleted 122 is invoked when an event has been received, which indicates that an attribute has been deleted.

As indicated above, abstract class delayedModelEventDispatcher is an example of a specific type of listener. All that is required for functionality is the actual “action” that must be performed. One example of such an action is represented as a method in FIG. 7. Class GUIRefreshListener 50 extends class delayedModelEventDispatcher 46 (shown in FIG. 46) and provides a method GUIRefreshListener 124 that creates a new GUIRefreshListener that requires a 5 second delay before refreshing a GUI (graphical user interface) panel, up to a maximum delay of 60 seconds. Method dispatchEvents 126 is the method that actually causes a GUI panel to refresh. Method dispatchEvents 126 takes an entire list of events and causes a GUI update after a 5 second delay between any two received events, or after a delay of 60 seconds, if an event occurs and no subsequent event occurs for 60 seconds or if an event occurs and no subsequent delay as long as 5 seconds occurs for the next 60 seconds. Upon the occurrence of the next event after a dispatch of events for a refresh has occurred, the process is repeated.

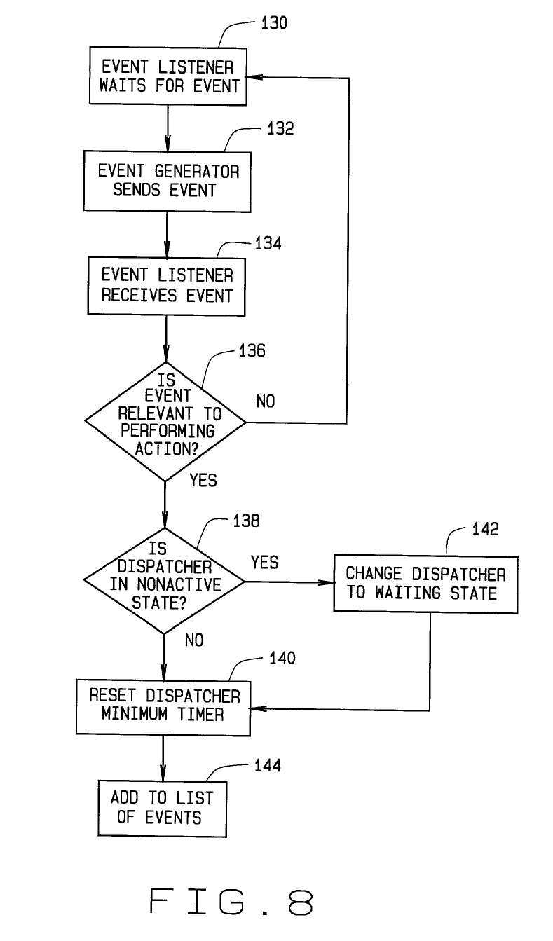

In one configuration and referring to FIG. 8, the above-described objects are utilized to prevent rapidly occurring events from overwhelming a computing system having an associated memory. An event listener waits 130 for an event signal that is eventually sent 132 by an event generator. The event listener receives 134 this event signal and determines 136 whether the event is relevant to performing an action utilizing predetermined relevance criteria. If not, the event listener ignores the event signal and waits 130 for another event signal to arrive. Otherwise, if the event signal is relevant, a determination is made 138 whether an event dispatcher is in a non-active state. If not, a “minimum timer” (i.e., a timer timing the time between events) is reset 140 to a predetermined first, or “minimum,” time limit. Otherwise, the event dispatcher is changed 142 to the waiting state and the minimum timer is reset 140. Upon resetting 140 the minimum timer, a change event corresponding to the received event signal is added 144 to an ordered list of change events.

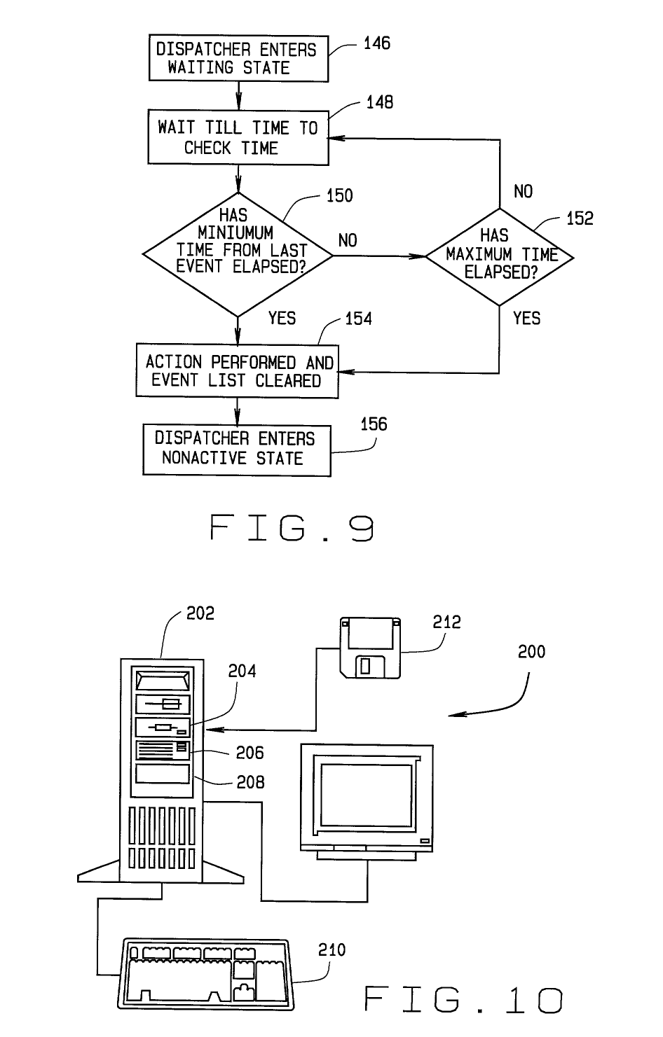

Referring to FIG. 9, when the event dispatcher enters 146 the waiting state (such as by being changed to the waiting state at block 142 of FIG. 8), it waits 148 for a period of time in one configuration before checking 150 whether the predetermined minimum time has elapsed since the most recently received relevant event. (Waiting 148 is desirable in some multithreaded embodiments, for example, to prevent excessive processor time from being wasted in a timing loop.) The predetermined first, or minimum, time limit in this configuration corresponds to the reset time at block 140 of FIG. 8. If the minimum time limit has not elapsed, a further check 152 is performed to determine whether a second, or “maximum,” predetermined time limit has elapsed since the most recently received relevant event signal. If the maximum time limit has also not elapsed, the dispatcher waits 148 again before checking the timers again. Otherwise, if either the predetermined minimum or the predetermined maximum times have elapsed, an action described by the list of change events is performed 154 (i.e., the list of change events is “dispatched”) and the list of change events is cleared. In one configuration, after the list of change events is cleared, the process of iteratively receiving event signals and adding change events, checking time limits, and dispatching lists of change events is repeated, each time with a new list of change events constructed from newly received signals.

By dispatching the entire list of change events rather than each event signal individually, efficiencies are realized. In particular, an event handler may use the list of change events to perform one or a few actions based upon a cumulative effect of the change events in the list of change events, rather than performing a large number of separate actions for each individual event signal as would otherwise be necessary if each event signal were acted upon individually. One manner in which a cumulative effect of change events is realized in one configuration is by buffering an effect of the individual change events in a memory of the computing apparatus until the cumulative effect is determined, and then producing the cumulative effect, such as by utilizing the contents of the memory buffer to produce an output display without displaying intermediate results while the cumulative effect is being determined. In this configuration, the list of change events is dispatched to a graphical user interface (GUI) display event listener configured to update a graphical user interface displayed on the display device. The graphical user interface is maintained until the cumulative effects of the list of change events is determined, and the display is updated in accordance with the determined cumulative effect, without displaying intermediate states of the display. This configuration is useful in many applications, and particularly in conjunction with database displays in which one or a few changes submitted to a database server can result in a flood of updates to a display due to database dependencies.

Note that FIGS. 8 and 9 represent separate threads of a program. Thus, an event listener can wait 130 for an event and add 144 relevant events to the list of events while a dispatcher is already in the waiting state 146. As events continue to be added 144, the waiting dispatcher will continue wait 148 and check for time-outs 150, 152 until a time-out occurs and an action performed 154. Thus, execution of the steps in FIG. 8 proceeds independently of the steps in FIG. 9 and vice versa, except that the steps of FIG. 9 are not executed unless a dispatcher has been changed 142 to a waiting state and the minimum time checked at 150 is reset 140 when relevant events arrive. In particular, receiving 134 an event signal from an event source or generator and adding 144 a change event corresponding to the received event signal will be iteratively repeated, at least for rapidly arriving groups of event signals, while neither time limit in determination blocks 150 and 152 is exceeded.

An example of a computing apparatus 200 configured to operate in accordance with the above description is represented in FIG. 10. In one configuration of the present invention, cabinet 202 houses a central processing unit (CPU) and associated random access memory (neither of which are shown separately in FIG. 8, but which are well-known in the art). In addition to random access memory, the CPU also communicates with other memory storage devices, for example, floppy disk drive 204, hard disk drive 206, and CD-ROM drive 208. In one configuration, machine readable instructions configured to instruct the computing apparatus are stored on hard disk drive 206 (or more generally, on one or more memory storage devices or media). In one configuration, machine readable instructions configured to control computing apparatus 200 to execute the steps and procedures of the configurations of the present invention described herein are recorded on one or more media 212, for example, one or more floppy diskettes or CD-ROMS.

It will thus be observed that configurations of the present invention allow a computer systems to handle floods of events without being overwhelmed, yet also allow the computer system to respond adequately to isolated events. In particular, in one configuration of the present invention, database transactions that cause a cascade of GUI display updates due to database relationships do not overwhelm either the capability of the GUI display update system or inhibit the usefulness of the GUI display to an observer.

The description of the invention is merely exemplary in nature and, thus, variations that do not depart from the gist of the invention are intended to be within the scope of the invention. Such variations are not to be regarded as a departure from the spirit and scope of the invention.

The following listings of JAVA files utilized in one configuration of the present invention correspond to FIGS. 3, 4, 5, 6 and 7 and their description above. The description of these Figures may be referred to in lieu of comments within the code listings themselves.

[image]

[image]

[image]

[image]

[image]

[image]

[image]

[image]

[image]

[image]

[image]

What is claimed is:

1. A method for operating a computer comprising:
(a) preselecting at least a first time limit and a second time limit;
(b) receiving an event signal from an event source;
(c) adding a change event corresponding to the received event signal to a list of change events in a memory of the computer;
(d) iteratively repeating steps (b) and (c) while neither the first predetermined time limit between consecutive said event signals is exceeded nor the second predetermined time limit since the receipt of a received event signal corresponding to a first change event in the list of change events is exceeded; and
(e) dispatching the list of change events for a thread upon expiration of any of the first predetermined time limit or the second predetermined time limit.

2. A method in accordance with claim 1 wherein the dispatched list of change events comprises a plurality of change events and said method further comprises buffering an effect of said change events until a cumulative effect of said plurality of change events is determined.

3. A method in accordance with claim 2 further comprising determining relevance of the event signals in accordance with predetermined relevance criteria, and wherein said adding a change event corresponding to the received event signal to a list of change events is performed only for event signals meeting the predetermined relevance criteria.

4. A method in accordance with claim 3 wherein said dispatching the list change events for a thread comprises dispatching the list of change events to a graphical user interface (GUI) display event listener configured to update a graphical user interface displayed on a display device, said method further comprising maintaining the graphical user interface until said buffering of effects of individual said change events is completed, and utilizing the GUI display event listener to update the graphical user interface displayed on the display in accordance with said determined cumulative effect of said plurality of change events.

5. A method in accordance with claim 4 wherein said receiving an event signal from an event source comprises receiving an event signal from a database server.

6. A method in accordance with claim 1 further comprising determining relevance of the event signals in accordance with predetermined relevance criteria, and wherein said adding a change event corresponding to the received event signal to a list of change events is performed only for event signals meeting the predetermined relevance criteria.

7. A method in accordance with claim 1 wherein at least steps (b) through (e) are iteratively repeated, and wherein a new list of change events is constructed for each iteration of steps (b) through (e).

8. A computing apparatus having a central processing unit operatively coupled to a memory, said apparatus configured to:
(a) store a predetermined first time limit and a predetermined second time limit in said memory;
(b) execute a plurality of concurrent program threads;
(c) construct a list of change events corresponding to event signals received by one said program thread while neither the first predetermined time limit between consecutive said event signals is exceeded nor the second predetermined time limit since the receipt of an earliest received event signal corresponding to a first change event in the list of change events is exceeded; and
(d) dispatch the list of change events for a thread upon expiration of any of the first predetermined time limit or the second predetermined time limit.

9. A computing apparatus in accordance with claim 8 wherein the dispatched list of change events comprises a plurality of change events and said computing apparatus is further configured to buffer an effect of said change events until a cumulative effect of said plurality of change events is determined.

10. A computing apparatus in accordance with claim 9 further configured to determine relevance of said event signals in accordance with predetermined relevance criteria, and to add a change event corresponding to a received event signal to a list of change events only when the event signal meets said predetermined relevance criteria.

11. A computing apparatus in accordance with claim 10 further comprises a display coupled to said central processing unit and said memory, and one of said concurrent program threads includes a graphical user interface (GUI) display event listener configured to update a graphical user interface displayed on said display;
wherein to dispatch the list change events for a thread, said computing apparatus is configured to dispatch the list of change events to the GUI display event listener; and
said computing apparatus is further configured to maintain the graphical user interface until said buffering of effects of individual said change events is completed, and to utilize the GUI display event listener to update said graphical user interface displayed on said display in accordance with said determined cumulative effect of said plurality of change events.

12. A computing apparatus in accordance with claim 8 further configured to determine relevance of said event signals in accordance with predetermined relevance criteria, and to add a change event corresponding to a received event signal to a list of change events only when the event signal meets said predetermined relevance criteria.

13. A computing apparatus in accordance with claim 8 wherein to dispatch said list of change vents for a thread, said computing apparatus is configured to specify a thread name and to dispatch said list of change events to a thread having the specified name.

14. A machine-readable medium or media having recorded thereon instructions configured to instruct a computing apparatus having a central processing unit operatively coupled to a memory to:
(a) store a predetermined first time limit and a predetermined second time limit in the memory;
(b) execute a plurality of concurrent program threads;
(c) construct a list of change events corresponding to event signals received by one said program thread while neither the first predetermined time limit between consecutive said event signals is exceeded nor the second predetermined time limit since the receipt of an earliest received event signal corresponding to a first change event in the list of change events is exceeded; and
(d) dispatch the list of change events for a thread upon expiration of any of the first predetermined time limit or the second predetermined time limit.

15. A medium or medium in accordance with claim 14 wherein said dispatched list of change events comprises a plurality of change events and said medium or media further have recorded thereon instructions to instruct the computing apparatus to buffer an effect of said change events until a cumulative effect of said plurality of change events is determined.

16. A medium or media in accordance with claim 15 further having recorded thereon instructions configured to instruct the computing apparatus to determine relevance of said event signals in accordance with predetermined relevance criteria, and to add a change event corresponding to a received event signal to a list of change events only when the received event signal meets said predetermined relevance criteria.

17. A medium or media in accordance with claim 16 one of said concurrent program threads includes a graphical user interface (GUI) display event listener configured to update a graphical user interface displayed on said display; and
wherein to dispatch the list change events for a thread, said medium or media has recorded thereon instructions configured to instruct the computing apparatus to dispatch the list of change events to said GUI display event listener; and
said medium or media also has recorded thereon instructions configured to instruct the computing apparatus to maintain the graphical user interface until said buffering of effects of individual said change events is completed, and to utilize the GUI display event listener to update said graphical user interface displayed on said display in accordance with said determined cumulative effect of said plurality of change events.

18. A medium or media in accordance with claim 14 further having recorded thereon instructions configured to instruct the computing apparatus to determine relevance of said event signals in accordance with predetermined relevance criteria, and to add a change event corresponding to a received event signal to a list of change events only when the received event signal meets said predetermined relevance criteria.

19. A medium or media in accordance with claim 14 wherein to dispatch said list of change vents for a thread, said medium or media further has recorded thereon instructions configured to instruct the computing apparatus to specify a thread name and to dispatch said list of change events to a thread having the specified name.

20. A medium or media in accordance with claim 14 further having recorded therein instructions configured to instruct the computing apparatus to iteratively repeat said constructing and dispatching, and to construct a new list of change events after each said dispatching of a list of event changes.
